(19) United States
(12) Patent Application Publication
(10) Pub. No.: US 2010/0031792 A1
(43) Pub. Date: Feb. 11, 2010

(54) Saw Assembly for Wood Product Sawing Apparatus and Method

(75) Inventor: Ronald W. McGehee, Ukiah, CA (US)

Correspondence Address: HAYNES BEFFEL & WOLFELD LLP, P O BOX 366, HALF MOON BAY, CA, 94019, US

(73) Assignee: McGehee Development Company LLC, Ukiah, CA (US)

(21) Appl. No.: 12/536,149

(22) Filed: Aug. 5, 2009

Related U.S. Application Data
(60) Provisional application No. 61/087,416, filed on Aug. 8, 2008.

(51) Int. Cl. B27B 5/36; B27B 7/04

(52) U.S. Cl. 83/34; 83/425.4; 83/433; 83/477.1

(57) ABSTRACT

A wood cutter assembly includes a saw assembly, a slewing assembly and a skewing assembly. The saw assembly includes a cutter assembly rotated about a drive axis by a drive shaft passing through an open region therein. The cutter assembly includes a cutter mounted to a cutter spindle for rotation about the open region. The cutter assembly is mounted to a spindle housing, which is pivotally mounted to a saw positioner for movement about a pivot axis. The pivot axis passes through the drive shaft transversely to the drive shaft axis. The cutter is slewed so to move the saw positioner, and the spindle housing and cutter assembly therewith, along the drive shaft. The cutter is skewed relative to the drive shaft axis over a range of skew angles by selectively rotating the spindle housing, and the cutter assembly therewith, about the pivot axis.

### CROSS-REFERENCE TO OTHER APPLICATIONS

This application claims the benefit of provisional patent application number 61/087,416, filed 8 Aug. 2008, attorney docket number MGDC 1006-1, the disclosure of which is incorporated herein by reference.

### BACKGROUND OF THE INVENTION

Many trees do not grow straight so that the logs cut from the trees are swept or curved in shape. Special procedures and equipment must be used to maximize the board feet of lumber cut from these imperfect logs. FIGS. 1A and 1B illustrate two typical swept or curved logs 2, 3. FIG. 2 is an end view of log 2 showing how the swept or curved feature is typically in a single plane. To create lumber from log 2, side boards 4, illustrated in FIG. 3, are, in this typical example, cut from log 2 by making cuts along lines 6, 7 on either side of log 2 so that each side board 4 has parallel, cut surfaces 8, 9 and unfinished, uncut edges 10, 11. These cuts are made in a conventional manner. What is left of log 2 is called a center cant illustrated as center cant 12 in FIG. 4.

Center cant 12 has opposite, parallel, cut surfaces 14, 15 which correspond to surfaces 9 of boards 4 made at cutting lines 7. The end 16 of center cant 12 in FIG. 4 has a number of dashed cut lines 18 corresponding to where cant 12 will be rip sawn to create center cant lumber 20. See also FIG. 5. To maximize the board feet of lumber from center cant 12, cut lines basically parallel the edges 22 of center cant 12. While the center cant lumber 20 will originally have the same curved or swept shape as center cant 12, most, if not all, of this curve can be removed during drying operations. Side boards 4 are cut differently than center cant 12 to maximize the amount of side board lumber 24 as suggested in FIG. 6. Using conventional computer-controlled edger optimizing systems, the number, size and position of center cant lumber 20 and side board lumber 24 are determined automatically using appropriate computer programs based upon profile information of the side board 4 or center cant 12 scanned into the computer.

For example, U.S. Pat. No. 4,239,072 discloses a method and apparatus for edge trimming a side board. A number of overhead pressure rolls engage the side board as the side board passes along a chain conveyor. The side board is centered by sets of centering rolls. A number of scanning gates are positioned above the conveyor to provide a computer with appropriate information on the profile of the side board. The edging assembly includes a pair of adjustable cutting heads designed to chip the unwanted edges from the side board. The cutting heads are slewed in a direction perpendicular to the direction of movement of the board by hydraulic cylinders so that one or more pieces of side board lumber can be cut from a single side board.

U.S. Pat. No. 4,449,557, assigned to the same assignee as U.S. Pat. No. 4,239,072, uses substantially the same system for delivering partially cut logs to an edging assembly as the '072 patent. However, instead of using angled edge chippers, as in the '072 patent, the '557 patent uses sawing disks or saw blades to make the edge cuts. The entire edger saw system moves as a unit so that the sawing disks can skew, that is change the angle between the axis of rotation of the sawing disks and the direction of feed of the work piece and can slew, that is move laterally along a line generally perpendicular to the direction of feed of the work piece.

Some conventional edger optimizer systems measure the boards transversely and then position the board onto a feeding mechanism and move the board longitudinally into the edger. This conventional method requires a considerable amount of expensive scanning, positioning and transporting equipment to carry out the process. Conventional systems also commonly create cumulative scanning, positioning and transport errors that make the systems somewhat less than optimal. With regard to the '557 patent, complex board centering mechanisms, multiple scanner heads, complex and high maintenance feeding and tracking devices, and complex high inertia edger rotation devices are all characteristic of the system described in the patent.

U.S. Pat. No. 5,761,979 and U.S. Pat. No. 5,870,939 describe a saw assembly that includes a rotatable arbor on which two or more saw blades are mounted. The driving interface between the saw blades and the arbor permits the axis of rotation of the saw blades to be collinear with the arbor axis or skewed a few degrees in either direction. A saw blade positioning assembly includes pairs of guide arms which engage the sides of the saw blades to position each saw blade at the proper location along the arbor and at the proper skew angle. The guide arms are moved in unison so that the axial position and the skew angle of each of the saw blades can be changed in unison before and during sawing operations.

In these designs, the guide arms that engage the sides of the rotating saw blades require constant maintenance and can often lead to problems. These saw guide arms require the use of saw blade lubricants and cooling water that reduce the fuel value of the saw dust and cause environmental and waste water concerns.

### BRIEF SUMMARY OF THE INVENTION

A first aspect of the invention is directed to a saw assembly usable as part of a wood product sawing apparatus. A drive shaft is supported by a frame and is rotatable about a drive shaft axis, the drive shaft comprising a first drive feature, such as an axially extending spline surface in some examples. A cutter assembly includes a cutter rotatably mounted to a cutter spindle. The cutter assembly defines an open region through which the drive shaft passes. The cutter assembly comprises a second drive feature engaging the first drive feature so that rotation of the drive shaft rotates the cutter assembly while permitting the cutter assembly to slide along the drive shaft in the direction of the drive shaft axis. The open region, in some examples a tapered open region, is configured to permit the cutter to be oriented on the drive shaft over a range of skew angles relative to the drive shaft axis. The cutter spindle is rotatably mounted to and supported by a pivoting spindle housing for rotation of the cutter about the drive shaft axis. The pivoting spindle housing is rotatably mounted to a saw positioner body for rotation of the pivoting spindle housing and cutter assembly therewith about a pivot axis. The pivot axis passes through the drive shaft in a direction transverse to the drive shaft axis. A skewing driver is mounted to the saw positioner body and is drivingly connected to the pivoting spindle housing to move the pivoting spindle housing about the pivot axis thereby skewing the cutter relative to the drive shaft axis over at least part of the range of skew angles. A slewing positioner, supported by the frame and connected to the saw positioner body, is operable to move the saw positioner body and the pivotal spindle housing and cutter assembly therewith along the drive shaft axis. In some examples the cutter assembly, pivoting spindle housing and saw positioner body constitute a cutting unit and the saw assembly further comprises a plurality of the cutting units with the drive shaft passing through the open regions of the cutter assemblies of the saw positioners.

A second aspect of the invention is directed to a wood cutter assembly, usable as part of a wood product sawing apparatus, including a saw assembly, a slewing assembly and a skewing assembly. The saw assembly comprises a cutter assembly having an open region, a drive shaft passing through the open region, a cutter spindle and a cutter mounted to the cutter spindle for rotation about the open region. The cutter assembly is mounted to a spindle housing. A saw positioner is supported by the frame. The spindle housing is pivotally mounted to the saw positioner for movement about a pivot axis. The pivot axis passes through the drive shaft transversely to the axis of the drive shaft. The slewing assembly, used to move the cutter along the drive shaft, comprises a saw positioner driver assembly engaging the saw positioner to move the saw positioner in a direction parallel to the drive shaft axis so the spindle housing and cutter assembly therewith move along the drive shaft. The skewing assembly, for moving the cutter relative to the drive shaft axis over a range of skew angles, comprises a spindle housing rotator assembly pivotally driving the spindle housing and the cutter assembly therewith about the pivot axis. The cutter assembly, spindle housing and saw positioner may be considered to constitute a cutting unit. Some examples comprise plurality of the cutting units with the drive shaft passing through the open regions of the cutter assemblies. In some examples separate saw positioner driver assemblies engage the saw positioner for each of the cutting units. In some examples one spindle housing rotator assembly pivotally drives the spindle housings and the cutter assemblies therewith about respective pivot axes for all of the cutting units.

A third aspect of the invention is directed to a method for slewing and skewing a wood cutter of a saw assembly, the saw assembly usable as part of a wood product sawing apparatus. A cutter assembly is rotated about a drive shaft axis by a drive shaft passing through an open region in the cutter assembly. The cutter assembly includes a cutter spindle and a cutter mounted to the cutter spindle for rotation about the open region. The cutter assembly is mounted to a spindle housing. The spindle housing is pivotally mounted to a saw positioner for movement about a pivot axis. The pivot axis passes through the drive shaft transversely to the drive shaft axis. The cutter is slewed along the drive shaft axis so to move the saw positioner, and the spindle housing and cutter assembly therewith, along the drive shaft. The cutter is skewed relative to the drive shaft axis over a range of skew angles by selectively rotating the spindle housing, and the cutter assembly therewith, about the pivot axis. In some examples a plurality of the cutter assemblies are rotated about the drive shaft axis. In some examples the slewing step is carried out by independently selectively moving the saw positioners. In some examples the skewing step is carried out by selectively rotating all of the spindle housings in unison.

Other features, aspects and advantages of the present invention can be seen on review the figures the detailed description, and the claims which follow.

### BRIEF DESCRIPTION OF THE DRAWINGS

FIGS. 1A and 1B are overall views showing two different types of curved or swept logs;

FIG. 2 is an end view of the log of FIG. 1A taken along line 2-2;

FIG. 3 is an enlarged view showing a side board cut from the log of FIG. 2;

FIG. 4 is an enlarged view showing a center cant cut from the log of FIG. 2;

FIG. 5 is a simplified top plan view of the center cant of FIG. 4 illustrating dashed cut lines and the resulting center cant lumber to be cut from the center cant;

FIG. 6 is a simplified top plan of the side board of FIG. 3 illustrating the outlines of side board lumber to be cut from the side board of FIG. 3;

FIG. 7 is a simplified top plan view of an example of a sawing apparatus made according to the invention;

FIG. 8 is a simplified side view of the apparatus of FIG. 7;

FIGS. 9 and 10 are enlarged front elevation and top plan views of a portion of the saw assembly of FIGS. 7 and 8 showing a set of three saw positioners and associated saw blades with the saw blades at a 2° cant;

FIG. 11 is an enlarged front, right side, top isometric view of a portion of the structure of FIGS. 9 and 10;

FIG. 12 is a front, left side isometric view of the structure of FIG. 11;

FIGS. 13 and 14 are top and front views of the structure of FIGS. 11 and 12;

FIG. 15 is a somewhat simplified cross-sectional view taken along line 15-15 of FIG. 14;

FIG. 16 is an enlarged cross-sectional view of a portion of the structure of FIG. 14 taken through the skewing drive shaft;

FIG. 17 is an enlarged isometric view of the structure of FIG. 16 with portions removed to show the engagement of the steering pin roller within the corresponding steering cam profile slot of the steering cam;

FIG. 18 is an enlarged view of a portion of the structure of FIG. 11 showing the engagement of the teeth of the spindle drive plate with the spline drive shaft 18;

FIG. 19 is an enlarged rear cross-sectional view of a portion of the structure of FIG. 14 showing the tapered opening in the saw spindle through which the spline drive shaft passes to accommodate skewing of the saw blade; and

FIG. 20 is an isometric cross-sectional view of the structure of FIG. 19.

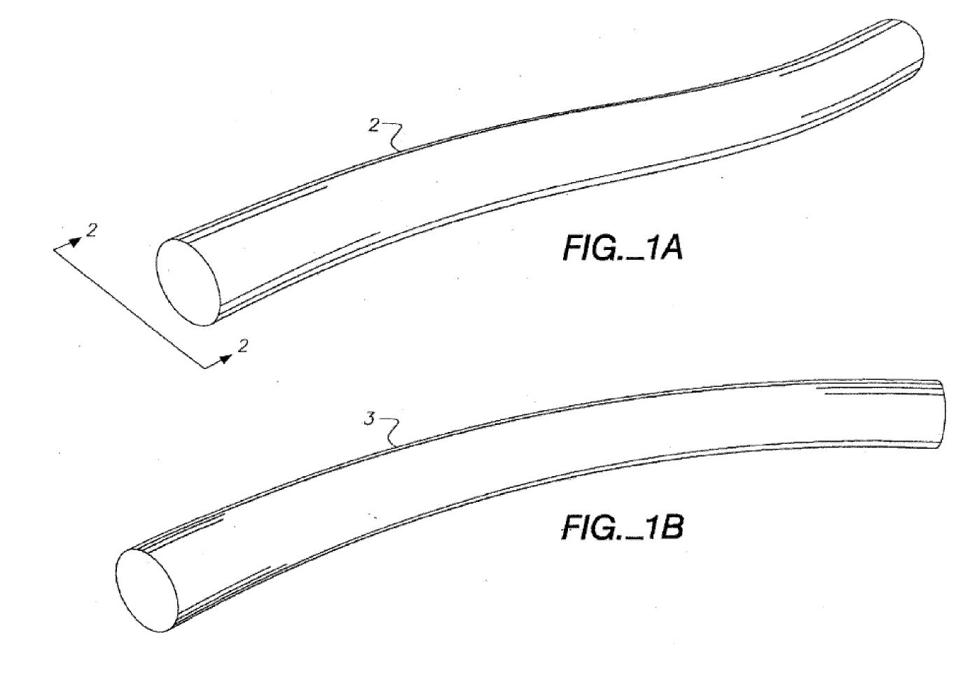

### LIST OF REFERENCE NUMERALS

2 Curved Log
3 Curved Log
4 Side Boards
6 Cut Lines
7 Cut Lines
8 Cut Surfaces
9 Cut Surfaces
10 Uncut Edges
11 Uncut Edges
12 Center Cant
14 Opposite, Parallel, Cut Surfaces
15 Opposite, Parallel, Cut Surfaces
16 End of Center Cant
18 Dashed Cut Lines
20 Center Cant Lumber
22 Edges of Center Cant
24 Side Board Lumber
26 Chipped Face of Center Cant
30 Sawing Apparatus
32 Infeed Assembly
34 Infeed Lug Chain
36 Partially Cut Log
38 Canted Drive Rolls
40 Fence
41 Longitudinal or Forward Direction
42 Lateral or Infeed Direction
44 Scanning Conveyor
46 Scanning Assembly
48 Scanner
50 Controller
52 Cutting Assembly
54 Pressroll Assembly
56 Saw Assembly
58 Driven Feed Chain
60 Pivotal Press Rolls
62 Drum Reman Head
64 Driven Exit Rolls
66 Sawn Lumber
68 Discharge Assembly
70 Paddle Picker Outfeed
72 Cutter Assembly
74 Saw Spindle
75 Saw Blades
76 Saw Positioner
78 Skewing Assembly
80 Saw Blade Slewing Assembly
82 Saw Positioner Body
84 Pivoting Spindle Housing
85 Fasteners
86 Spindle Bearings
87 Clamping Collar
88 Annular Side Surface of Saw Blade
89 Saw Spindle Drive Plate
90 Saw Shift Axis
91 Teeth of Spindle Drive Plate
92 Vertical Pivot Axis of 84
93 Spline Drive Shaft
94 Skewing Angle
95 Rotation Axis of 93
99 Spindle Rotation Axis
101 Rotation Axis of Fixed Drive Source
114 Skewing Positioner
116 Skewing Drive Shaft
118 Bell Crank Arm
117 Sliding Steering Cam Assembly
119 Pivot Bearings
120 Steering Arm Retainer
121 Thrust Washers
123 Skewing Cam Retainer
124 Steering Cam
125 Steering Pin Roller
126 Linear Bearings
128 Saw Assembly Frame
130 Steering Arm
131 Fixed Drive Source
132 Steering Pin
133 Steering Cam Bushing
136 Linear Positioner
140 Outer Bearing Retainer
141 Feed Path
142 Inner Bearing Retainer
143 Anti-Collision Pad
144 Steering Cam Profile Slot
166 Shift Shaft
167 Dummy Shift Shaft
168 Openings in 82 for 166
170 Support Shaft
172 Openings in 82 for 170
174 Tapered Opening in 74

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

The present invention is directed to a wood product assembly, such as an improved saw assembly for an edge trimming and board ripping apparatus, and method which provides a greatly simplified approach to, for example, optimally edging and ripping boards.

The edge trimming and board ripping apparatus includes an improved saw assembly used as a part of a sawing apparatus. The sawing apparatus, in one example, includes an in-feed assembly which delivers side boards or center cants one at a time to a scanning assembly. The side boards and center cants both have two parallel cut surfaces and are referred to generically as partially cut logs, cut logs or just logs. The scanning assembly preferably includes a scanner adjacent to a scanning conveyor. The scanner scans the cut log and provides a profile of the log to a computer which controls the operation of the improved saw assembly. The saw assembly is preferably part of a cutting assembly. The cutting assembly typically includes a press roll assembly which maintains the cut log in the same orientation, passing through the saw assembly, as the cut log had when it passed the scanner.

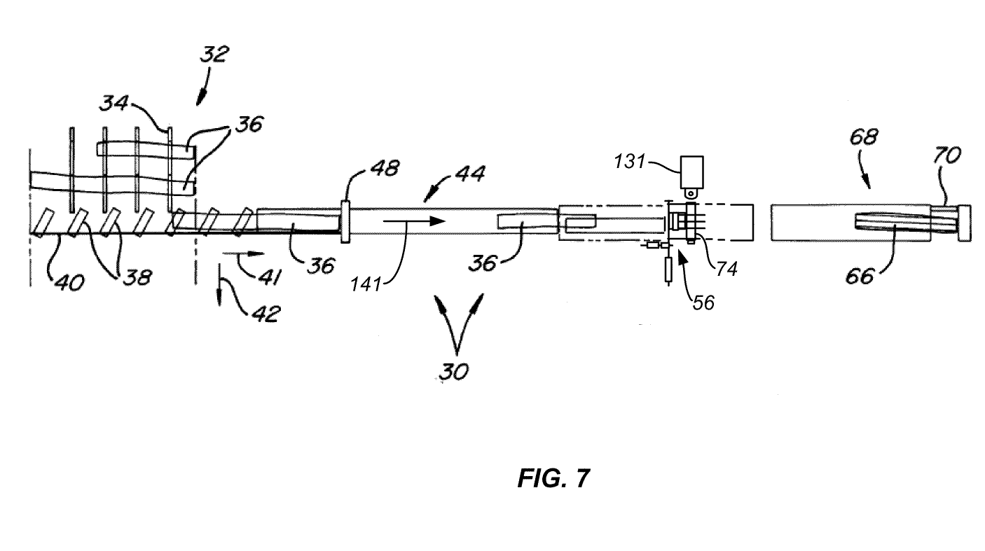

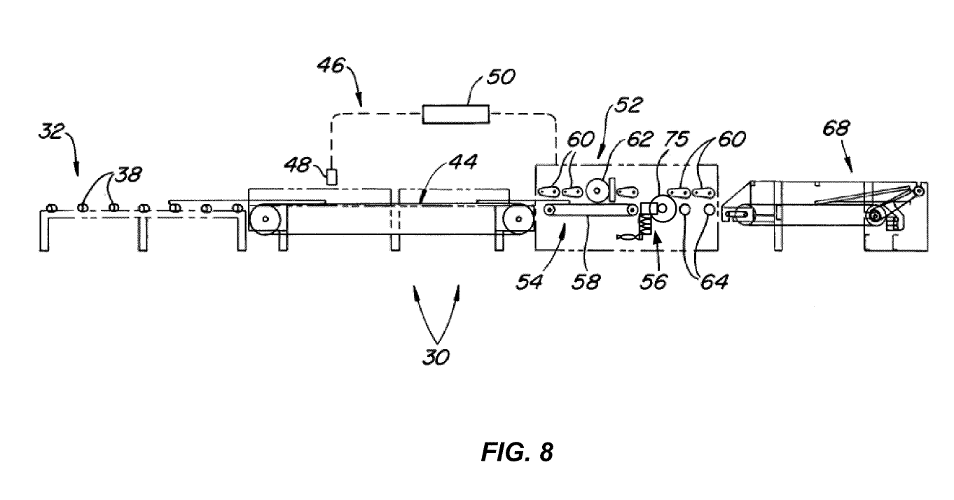

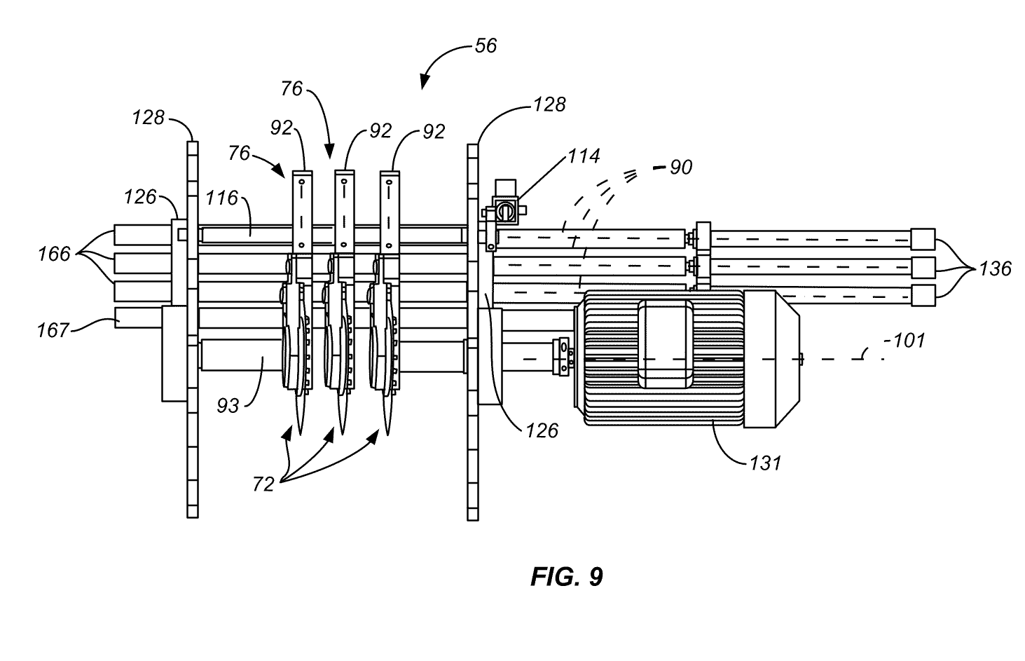

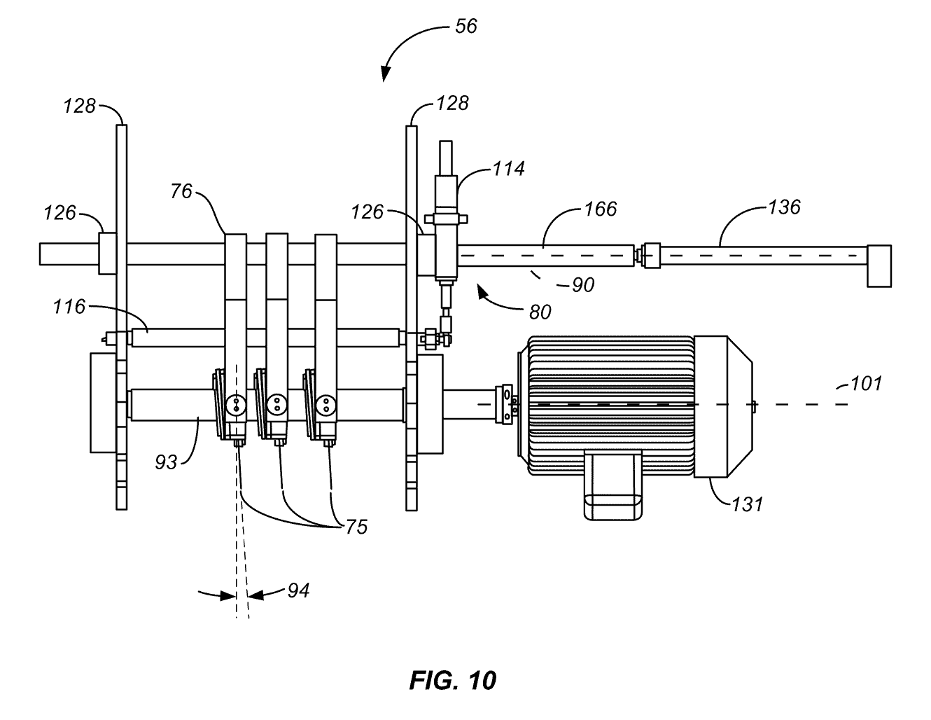

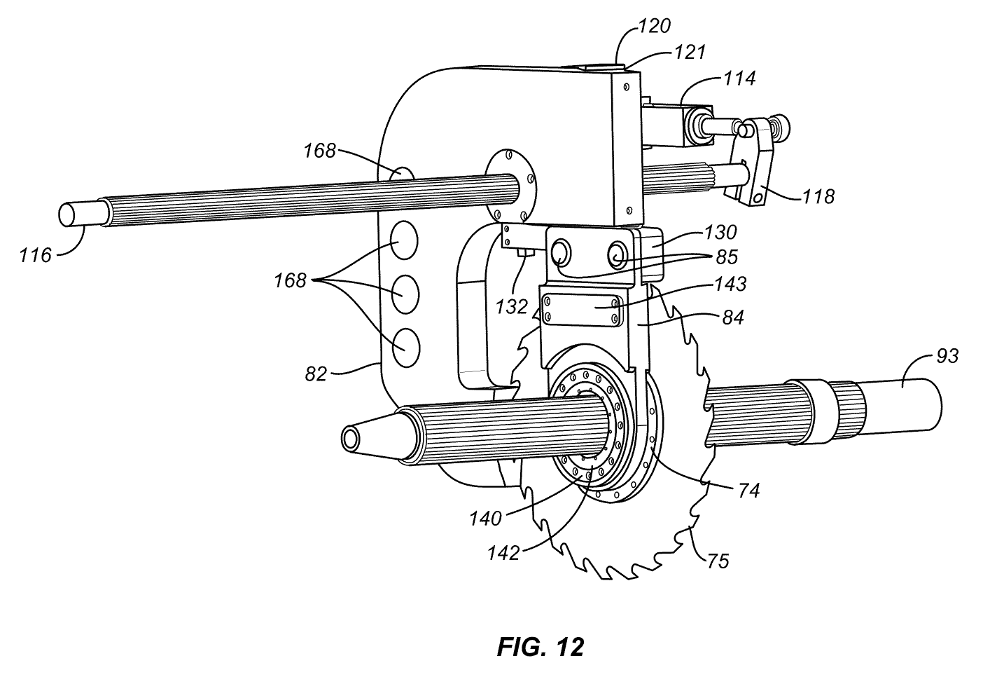

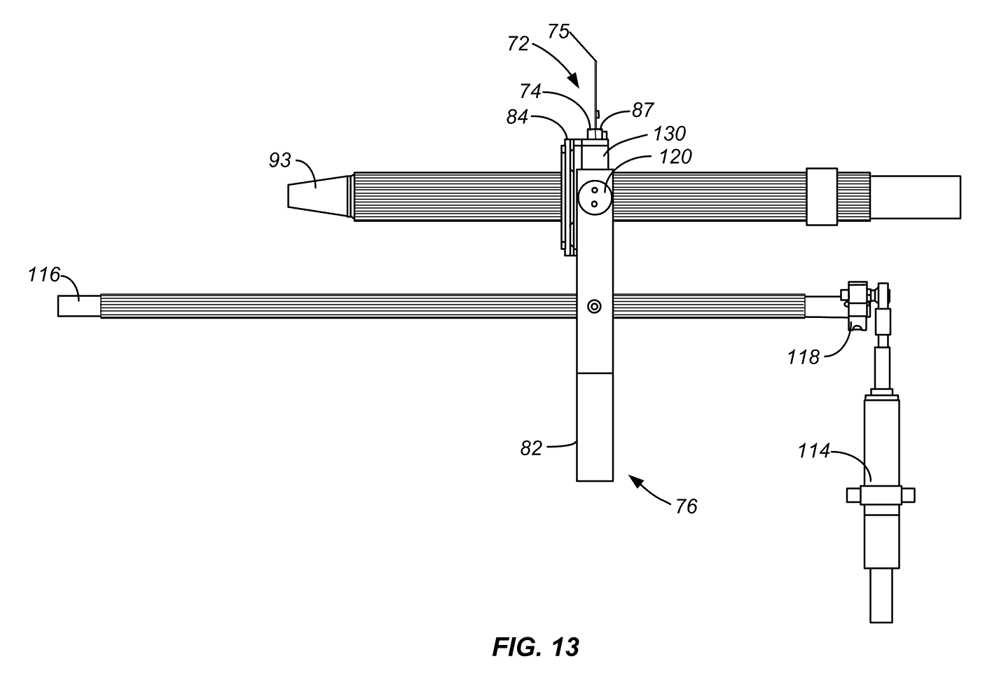

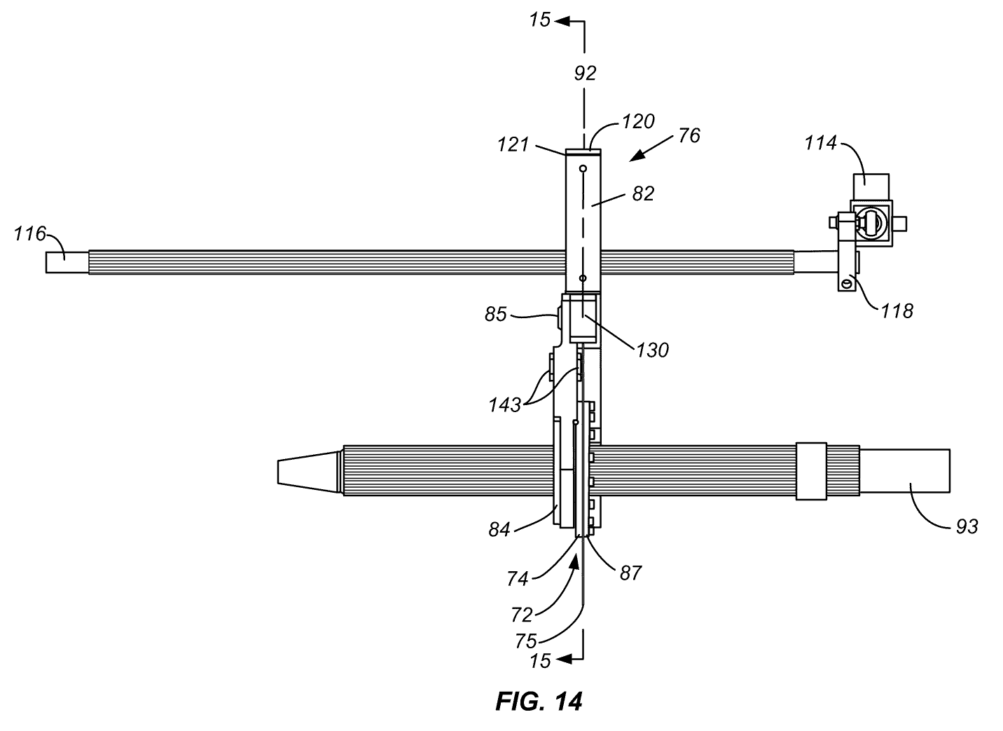

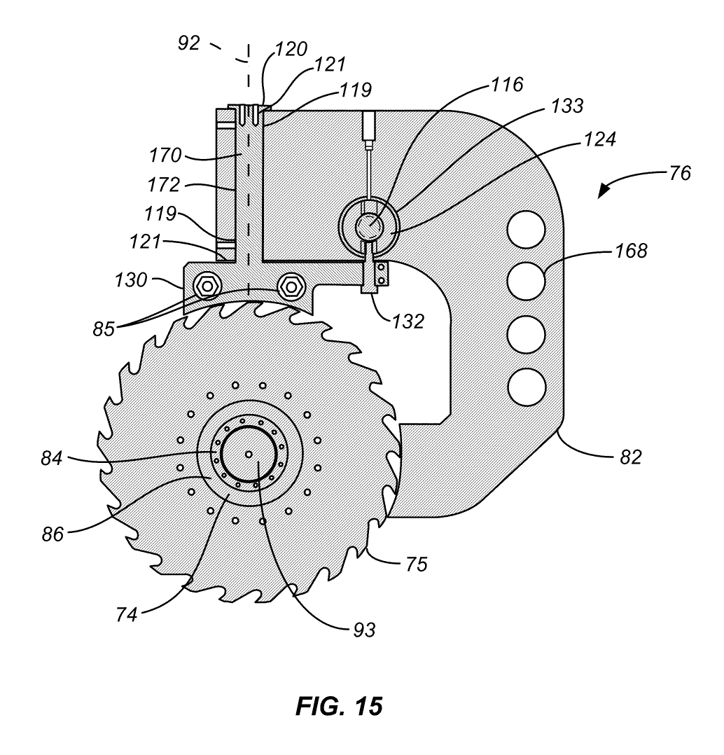

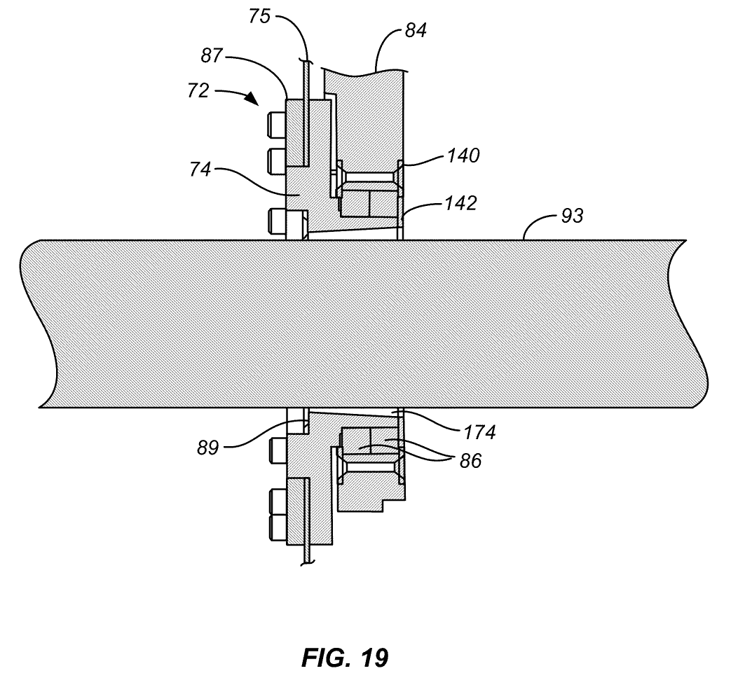

A saw assembly 56, see FIGS. 7-12, includes two or more cutter assemblies 72. In this example each cutter assembly 72 comprises a saw blade 75 and a saw spindle 74. Three cutter assemblies 72 are shown in FIGS. 9 and 10. Each saw blade 75 is individually supported, positioned and driven by subcomponents of saw assembly 56 as follows. Each saw blade 75 is rigidly attached to saw spindle 74. Each saw spindle 74 and saw blade 75, connected and rotating together, is mounted in a pivoting spindle housing 84. The pivoting spindle housing 84 contains spindle bearings 86 (see FIGS. 15 and 19) that allow free rotational movement of the saw spindle 74. Each pivoting spindle housing 84 is pivotally mounted to a saw positioner body 82 of a saw positioner 76 through a steering arm 130. See FIGS. 12 and 15. The combination of cutter assembly 72, spindle housing 84 and saw positioner body 82 is sometimes referred to in this application as a cutting unit. Steering arm 130 is mounted to pivoting spindle housing 84 by fasteners 85. Steering arm 130 includes a support shaft 170 passing upwardly through a corresponding opening 172 formed in saw positioner body 82 along a vertical pivot axis 92. Steering arm 130 is retained in place by a steering arm retainer 120. Thrust washers 121 are positioned at either end of opening 172 between corresponding surfaces of saw positioner body 82, steering arm retainer 120 and the main body of steering arm 130.

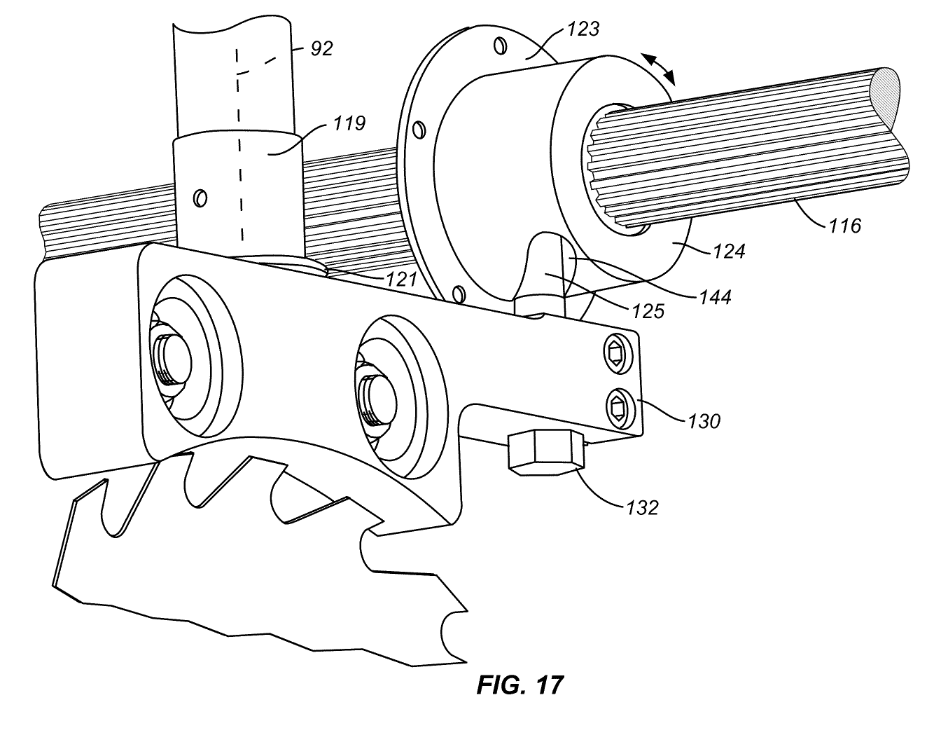

Each saw positioner body 82 supports a pivoting spindle housing 84 through steering arm 130 while allowing the spindle housing to turn at a slight angle about vertical pivot axis 92 to facilitate saw skewing (typically approximately ±5 degrees) through the use of two pivot bearings 119 as shown in FIGS. 15 and 17. The saw positioner 76 also shifts (repositions) positioner body 82 in a linear motion at a right angle (or transversely) to the log's direction of travel or feed path 141 to provide the required slewing movement of the saw blade/saw spindle assembly during saw operation.

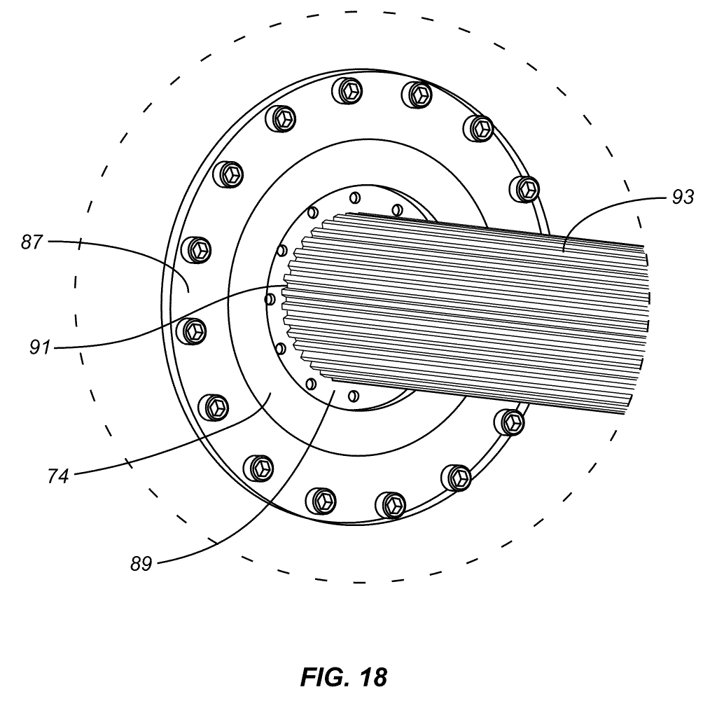

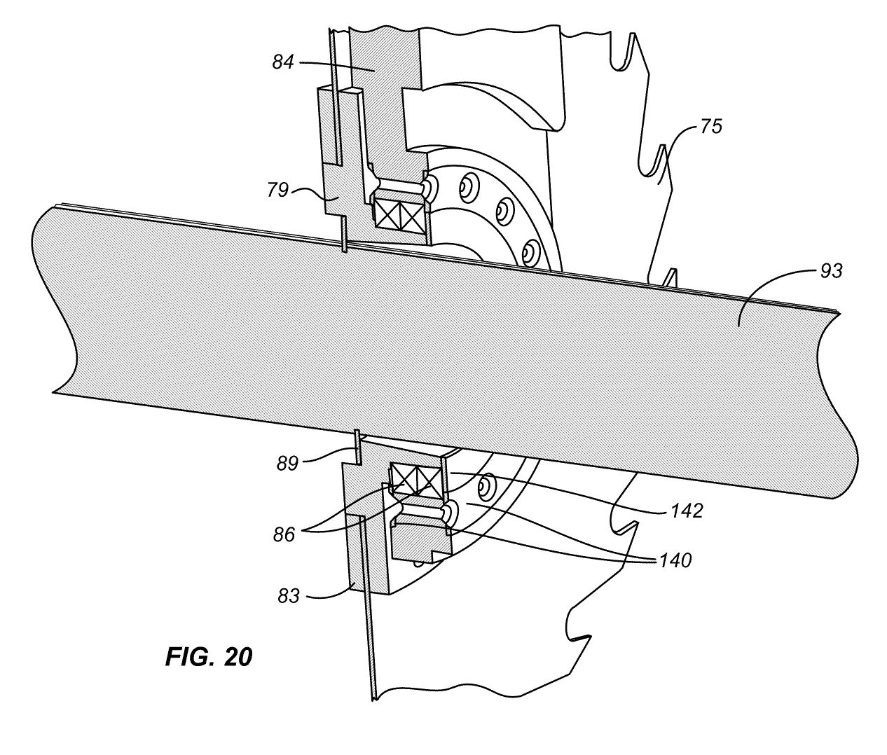

Each saw spindle 74 is coupled to and rotatable driven by a splined spindle drive plate 89 engaging a spline drive shaft 93 as shown in FIG. 18. The engagement clearance (typically 0.025″) between the female spline of the spindle drive plate 89 and the male spline of the spline drive shaft 93 is sufficient to allow the spindle drive plate to be skewed, that is to rotate about vertical pivot axis 92 approximately ±5 degrees. As seen in FIGS. 19 and 20, spindle 74 has a tapered opening 174 to permit this skewing without binding. Spline drive shaft 93 is coupled to a drive source 131; drive source 131 is typically fixed. Examples of drive source 131 include a fixed motor 131 or a fixed drive shaft coupled to a remote drive motor 131. The axis of rotation 101 of drive source 131 is preferably at a right angle to the log's direction of travel 14land generally parallel to the saw shift axes 90 (see FIGS. 10, 11 and 12).

The spindle drive plate 89 transmits torque to the saw spindle 74 while allowing both: (1) the axis of rotation of the saw spindle to turn at an angle relative to the axis of rotation of the spline drive shaft 93, that is skew, and (2) the saw spindle to move closer to or further away from drive source 131, that is slew.

FIGS. 9 and 10 show an embodiment of a saw assembly when composed of 3 saw blades. In this example three shift shafts 166 and one dummy shift shaft 167 support and position each saw positioner 76. Shift shaft 166 and dummy shift shaft 167 pass through openings 168 in saw positioner body 82 (see FIG. 12). Dummy shift shaft 167 would be replaced by a shift shaft 166 if a fourth saw positioner 76 were to be used. Each body 82 of each saw positioner 76 is rigidly connected to one of its shift shafts 166 and slides on the others. The three shift shafts 166 and the dummy shift shaft 167 that support the saw positioners are supported on each end by the saw assembly frame 128 (see FIG. 9). Linear positioners 136, see FIGS. 9 and 10, located outside and connected to the saw assembly frame 128, are coupled to each shift shaft 166 and individually actuate each shift shaft to provide the required saw positioning and slewing motion for each saw blade 75 along each saw shift axis 90 during saw operation. Linear bearings 126, see FIGS. 9 and 10, are used where the shift shafts 166 intersect the saw assembly frame 128 to provide the proper guidance and support.

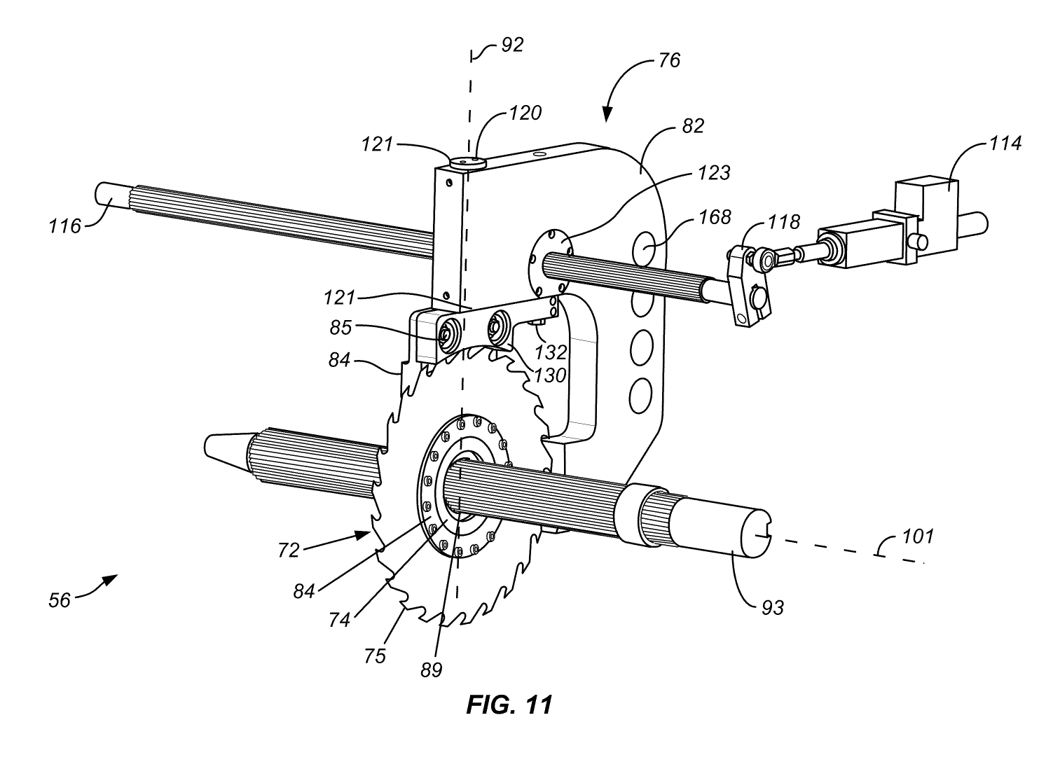

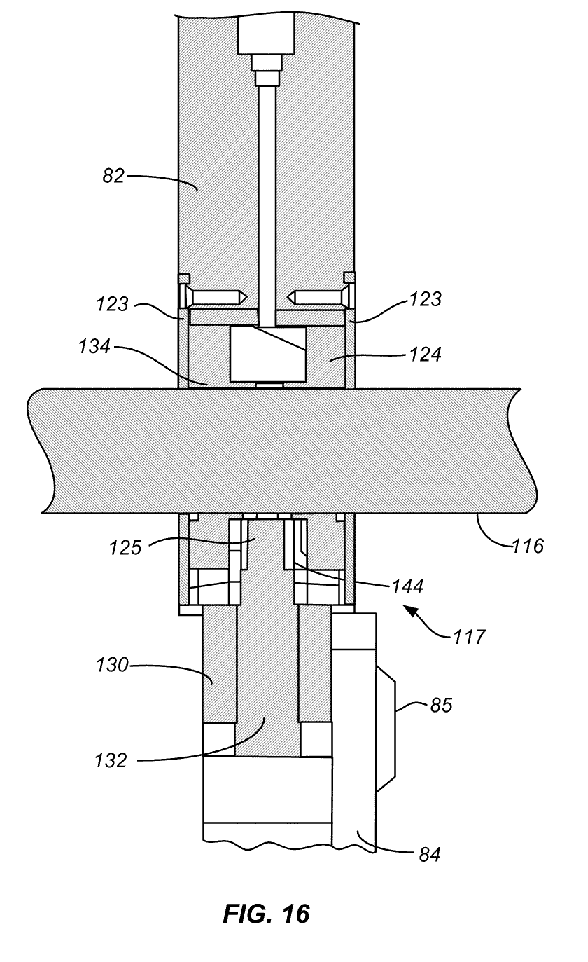

In this embodiment, a skewing drive shaft 116, see FIGS. 11 and 17, is used to skew the saw blade/saw spindle assembly 74, 75 during saw operation. Skewing drive shaft 116 extends parallel to saw shift axes 90 (see FIG. 9). A single skewing positioner 114 actuates the rotation of the skewing drive shaft. The skewing drive shaft 116 is linked to the pivoting saw spindle housing 84 through a sliding steering cam assembly 117 (see FIGS. 15-18) including a steering cam 124 rotating in bushing 133 in saw positioner 82. Steering cam assembly 117 is coupled to steering arm 130 through steering pin 132 and roller 125 engaging steering cam profile slot 144. Pivoting spindle housing 84 attaches to steering arm 130 with fasteners 85. The sliding steering cam assemblies 117 move along the skewing drive shaft 116 because they are captivated in the saw positioner bodies 82 by retainer plates 123 (following the slewing motion of the saw positioner 76 specific to each saw blade 75) and also rotate with the skewing drive shaft 116 (through a splined or keyed connection). The sliding steering cam assembly 117 is connected by steering pin 132 and roller 125 to the steering arm 130. Steering arm 130 is rigidly connected to the pivoting spindle housing 84 by fasteners 85. Therefore, rotation of skewing drive shaft 116 by skewing cylinder 114 rotates sliding steering cam assembly 117 which drives roller 125 along steering cam profile slot 144 causing steering arm 130 and spindle housing 84 therewith to pivot about axis 92 to provide the required saw blade skewing or angular motion.

With the present invention, side board lumber can be cut from side boards by edge trimming the side board and, optionally, rip sawing the side board to create one or more pieces of side board lumber. Also, center cants can be simultaneously edge trimmed and rip sawed to create center cant lumber from the center cant using the saw assembly made according to the invention.

One of the primary advantages of the invention is its simplicity. The partially cut log 36 need not be centered on the scanning conveyor 44 or the feed chain 58 of the press roll assembly 54 but rather simply placed somewhere on the scanning conveyor. Therefore, no centering rolls, as are used with conventional edger systems, are needed. Also, the present invention is designed to be used with only a single scanner, as opposed to the multiple scanners used with conventional systems, thus reducing cost. In addition, the present invention is adapted for use for both edge trimming and board ripping of both side boards and center cants making it very flexible.

An additional advantage is that the saw blade slewing assembly 80, which includes linear positioners 136, shift shafts 166 and linear bearings 126, is used to both initially position the saw positioners 76 and saw blades 75 therewith at the desired locations as well as slew, in unison, the saw blades while sawing the log. Also, the same structure, that is saw positioner 76, used to laterally position the saw blades is used to keep the saw blades at the proper skewing angle. Thus, of the actual sawing components (motor 131, arbor 93, saw blades 75, support frame 128), the only components which must move during sawing operations are the saw blade positioner assemblies 76; the electric motor 131, or other drive source, which drives the saw spindles 74 as well as the support frame 128 which supports the motor and spindle assemblies, can remain stationary. The complicated slewing and skewing schemes used with conventional edger systems are eliminated.

Another advantage of the invention is that the saw blades 75 require no guide arms to provide the positioning and stabilization. The use of saw guide arms adds complexity to the sawing system along with requiring constant maintenance. The sawing accuracy of the invention is higher than with a system using saw guide arms because of the rigid mounting of the saw assembly. The guide arms require a complex lubricating and cooling system to properly guide, position and stabilize the saw blades. The use of this saw blade lubricating and cooling system increases operating cost and causes the saw dust to be wet reducing its value as a fuel. Excess saw blade cooling water can find its way into storm drains, streams and rivers and cause environmental damage and well as contaminate ground water.

The above descriptions may have used terms such as above, below, top, bottom, over, under, et cetera. These terms are used to aid understanding of the invention are not used in a limiting sense.

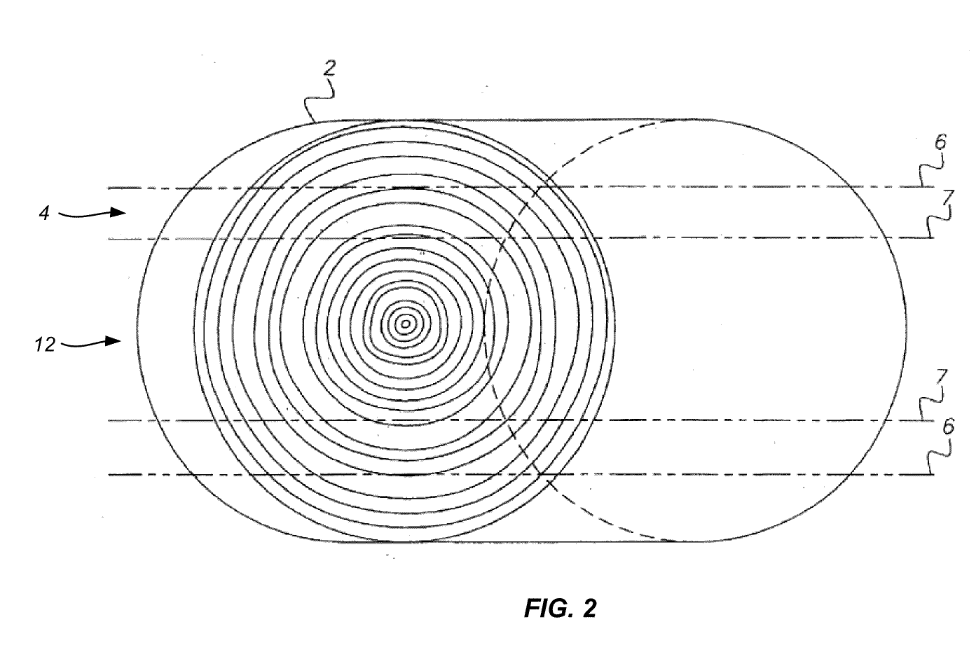

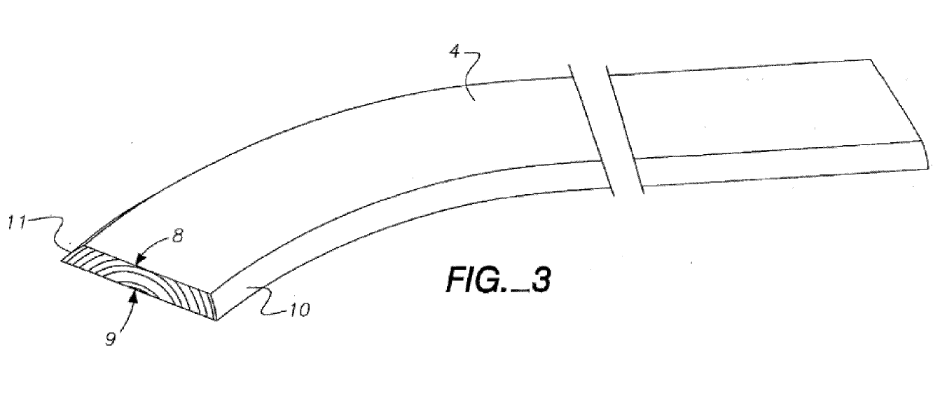

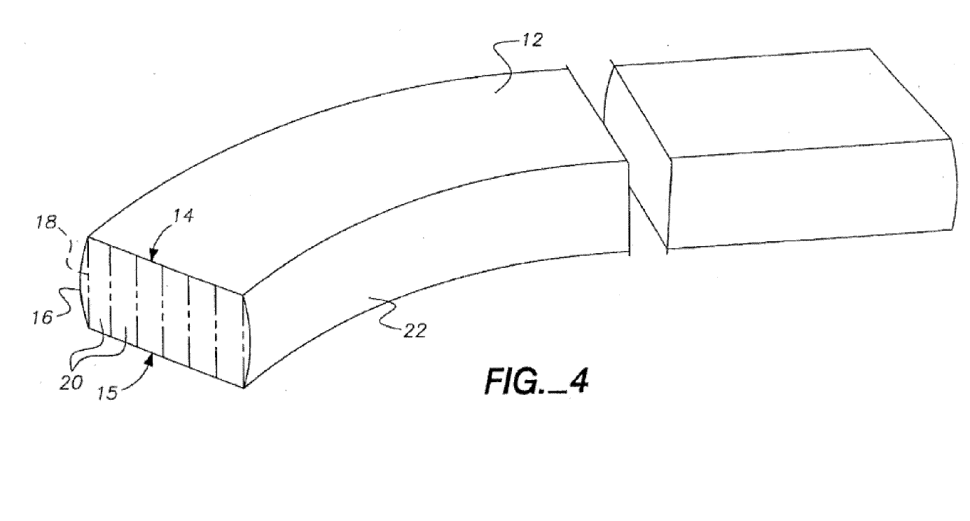

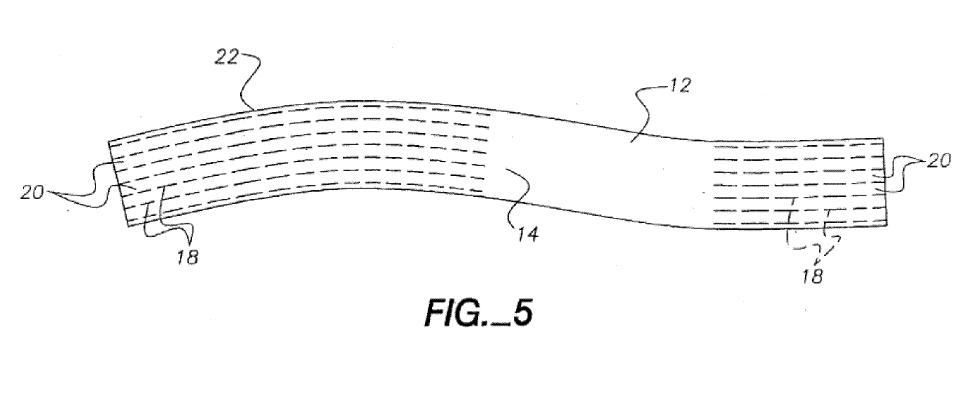

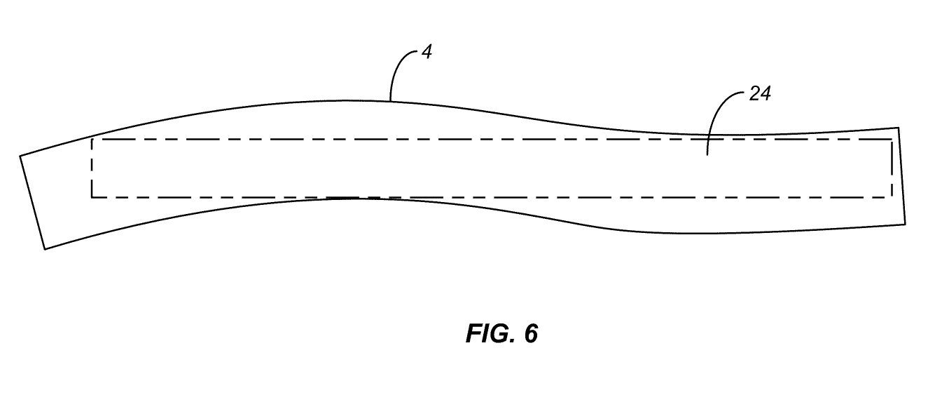

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, the proportions and numbers of center cant 12, center cant lumber 20, side boards 4, and side board lumber 24 illustrated in FIGS. 2-6 are simply one example for one particular log 2; some logs may produce no side board lumber. Different configurations of the invention can be used to allow varying numbers of saw blade positioners 76. Various types of cutters, such as wood chippers, can be used instead of or in addition to saw blades 75.

Any and all patents, patent applications and printed publications referred to above are incorporated by reference.

What is claimed is:

1. A saw assembly, usable as part of a wood product sawing apparatus, comprising:
a fame;
a drive shaft supported by the frame and rotatable about a drive shaft axis, the drive shaft comprising a first drive feature;
a cutter assembly comprising a cutter spindle and a cutter rotatably mounted to the cutter spindle, the cutter assembly defining an open region through which the drive shaft passes;
the cutter assembly comprising a second drive feature engaging the first drive feature so that rotation of the drive shaft rotates the cutter assembly while permitting the cutter assembly to slide along the drive shaft in the direction of the drive shaft axis;
the open region configured to permit the cutter to be oriented on the drive shaft over a range of skew angles relative to the drive shaft axis;
a pivoting spindle housing;
the cutter spindle rotatably mounted to and supported by the pivoting spindle housing for rotation of the cutter about the drive shaft axis;
a saw positioner body;
the pivoting spindle housing rotatably mounted to the saw positioner body for rotation of the pivoting spindle housing and cutter assembly therewith about a pivot axis, the pivot axis passing through the drive shaft in a direction transverse to the drive shaft axis;
a skewing driver mounted to the saw positioner body and drivingly connected to the pivoting spindle housing to move the pivoting spindle housing about the pivot axis thereby skewing the cutter relative to the drive shaft axis over at least part of the range of skew angles; and
a slewing positioner, supported by the frame and connected to the saw positioner body, operable to move the saw positioner body and the pivotal spindle housing and cutter assembly therewith along the drive shaft axis.

2. The saw assembly according to claim 1, wherein at least one of the first and second drive features comprises an axially extending spline surface.

3. The saw assembly according to claim 1, wherein the open region is a tapered open region.

4. The saw assembly according to claim 1, wherein the pivot axis passes through the drive shaft axis in a direction perpendicular to the drive shaft axis.

5. The saw assembly according to claim 1, wherein the range of skew angles is plus or minus 5°.

6. The saw assembly according to claim 1, wherein the cutter assembly, pivoting spindle housing and saw positioner body constitute a cutting unit, and further comprising a plurality of the cutting units with the drive shaft passing through the open regions of the cutter assemblies of the saw positioners.

7. The saw assembly according to claim 1, wherein the cutter comprises a circular saw blade.

8. A wood cutter assembly usable as part of a wood product sawing apparatus, comprising:
a saw assembly comprising:
a cutter assembly having an open region;
a drive shaft, having a drive shaft axis, passing through the open region of the cutter assembly;
the cutter assembly comprising a cutter spindle and a cutter mounted to the cutter spindle for rotation about the open region;
a spindle housing, the cutter assembly being mounted to the spindle housing;
a frame; and
a saw positioner supported by the frame, the spindle housing pivotally mounted to the saw positioner for movement about a pivot axis, the pivot axis passing through the drive shaft transversely to the drive shaft axis;
a slewing assembly for moving the cutter along the drive shaft, the slewing assembly comprising:
a saw positioner driver assembly engaging the saw positioner to move the saw positioner in a direction parallel to the drive shaft axis so the spindle housing and cutter assembly therewith move along the drive shaft; and
a skewing assembly for moving the cutter relative to the drive shaft axis over a range of skew angles, the skewing assembly comprising:
a spindle housing rotator assembly pivotally driving the spindle housing and the cutter assembly therewith about the pivot axis.

9. The wood cutter assembly according to claim 8, wherein the cutter assembly, spindle housing and saw positioner constitute a cutting unit, and further comprising a plurality of the cutting units with the drive shaft passing through the open regions of the cutter assemblies of the saw positioners.

10. The wood cutter assembly according to claim 9, further comprising a separate saw positioner driver assembly engaging the saw positioner for each said cutting unit.

11. The wood cutter assembly according to claim 9, wherein one said spindle housing rotator assembly pivotally drives the spindle housings and the cutter assemblies therewith about respective pivot axes for all of said cutting units.

12. The wood cutter assembly according to claim 11, wherein said spindle housing rotator assembly comprises a common skewing drive shaft for all of said cutting units.

13. A method for slewing and skewing a wood cutter of a saw assembly, the saw assembly usable as part of a wood product sawing apparatus, the method comprising:
rotating a cutter assembly about a drive shaft axis by a drive shaft passing through an open region in the cutter assembly, the cutter assembly comprising a cutter spindle and a cutter mounted to the cutter spindle for rotation about the open region, the cutter assembly mounted to a spindle housing, the spindle housing pivotally mounted to a saw positioner for movement about a pivot axis, the pivot axis passing through the drive shaft transversely to the drive shaft axis;
slewing the cutter along the drive shaft axis, the slewing step comprising:
selectively moving the saw positioner, and the spindle housing and cutter assembly therewith, along the drive shaft;
skewing the cutter relative to the drive shaft axis over a range of skew angles, the skewing step comprising:
selectively rotating the spindle housing, and the cutter assembly therewith, about the pivot axis.

14. The method according to claim 13, further comprising rotating a plurality of the cutter assemblies about the drive shaft axis.

15. The method according to claim 14, wherein the slewing step is carried out by independently selectively moving the saw positioners.

16. The method according to claim 14, wherein the skewing step is carried out by selectively rotating all of the spindle housings in unison.
